(19) United States
(12) Patent Application Publication
(10) Pub. No.: US 2009/0041958 A1
(43) Pub. Date: Feb. 12, 2009

(54) NON-METAL CONSUMER GOODS WITH AESTHETIC POWDER COATING

(76) Inventors: Michael J. Gmerek, Massillon, OH (US); Nathan Johnson, Birmingham, MI (US)

Correspondence Address: MOORE & VAN ALLEN PLLC, P.O. BOX 13706, Research Triangle Park, NC, 27709, US

(21) Appl. No.: 11/835,584

(22) Filed: Aug. 8, 2007

(51) Int. Cl. B65F 1/00; B32B 9/00

(52) U.S. Cl. 428/34.1; 428/411.1

(57) ABSTRACT

A powder coated non-metal consumer good with added aesthetic appeal. The non-metal consumer good has an outer surface and an inner surface. At least a portion of the outer surface has a powder coating applied increasing the aesthetic look of the consumer good.

### BACKGROUND

Currently, there is no good solution for adding aesthetic value (e.g., high gloss, metal look, texture, etc) to non-metal consumer goods such as indoor waste cans, totes, coolers, outdoor refuse, etc. at an affordable price. Opening Price Point (OPP) resin products that exist today have a “plastic” look. Moreover, High Price Point (HPP) products made of metal, (e.g., stainless steel, etc.) exist. These products have a high end look but also are relatively high price. Moreover, metal products that have a good aesthetic look may have other quality issues, for example, they can rust, dent, are hard to clean, need a plastic liner, and are heavy.

There exists a lamination technology where a decorative film is laminated to a plastic part. However, this technology limits the geometry of the product in order to get good lamination. For example, 2-axis, curved, or spherical surfaces are difficult or impossible to laminate. Wet painting also exists however this does not give texturing capability, is not environmentally friendly, and scratches easily. Pigmentation with metal flakes is also commercially available however this gives undesirable flow marks in the molded part. In addition, plastic parts can be plated (e.g., chrome, etc.), however, this process has problems in that it is extremely expensive and has durability issues.

### SUMMARY

Embodiments of the present invention are directed to a non-metal consumer good with added aesthetic appeal. The non-metal consumer good has an outer surface and an inner surface. At least a portion of the outer surface has a powder coating applied increasing the aesthetic look of the consumer good. The portion may be an entire outer surface or less than the entire outer surface.

In addition, embodiments of the present invention are directed to a waste container that includes a receptacle made of a plastic material and having an interior space for receiving waste. The receptacle may contain an inside surface and an outer surface. The inside surface exposes the plastic material. At least a portion of the outer surface has a powder coating applied increasing the aesthetic look of the plastic waste container. The portion may be an entire outer surface or less than the entire outer surface.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a diagram of groups of powder coated non-metal consumer goods according to example embodiments of the present invention;

FIGS. 2A and 2B are diagrams of a waste receptacle and associated cover, respectively; and

FIG. 3 shows diagrams of example plastic powder coated consumer goods according to example embodiments of the present invention.

### DETAILED DESCRIPTION OF EMBODIMENTS OF THE INVENTION

The following detailed description of embodiments refers to the accompanying drawings, which illustrate specific embodiments of the invention. Other embodiments having different structures and operation do not depart from the scope of the present invention.

Embodiments according to the present invention involve powder coating non-metal consumer goods (e.g., plastic indoor waste cans). Non-metal consumer goods may be made of any type of non-metal material such as, for example, plastic, ceramic, wood, etc. For illustration purposes, embodiments of the present invention will be described where the non-metal consumer goods are made of plastic. However, embodiments according to the present invention are not limited by this non-metal material, but cover consumer goods made from any type of non-metal material. Moreover, the process used to powder coat the non-metal consumer goods may be any type process and still be within the scope of the present invention. For illustrative purposes, a process for powder coating a plastic consumer good is generally described following. However embodiments of the present invention are not limited to this example process.

In the case of plastic, the process may involve molding an article with nylon or any other thermoplastic resin with a high heat deflection temperature (e.g., >325 F). The injection molded part can then be put through a powder coat process to heat cure the coating.

Plastic consumer products may be produced using a plastic part made with a glass filled (e.g., up top 30%) nylon resin. The glass filled resin may have better dimensional stability when going through the powder coat process. Regrind or recycled nylon may be used and may be better for cost purposes. Regrind resins may cause some visual defects, however since the product is being coated, these defects may not be not an issue. The consumer product may be made of other suitable plastic materials.

The molded part is then put through a powder coating process at the coater. Only the outside or show surfaces of the part are powder coated. This leaves the inside (specifically for a waste can) as a black (or any other color, depending on the color of the resin) easy to clean surface that is perceived as an inner liner.

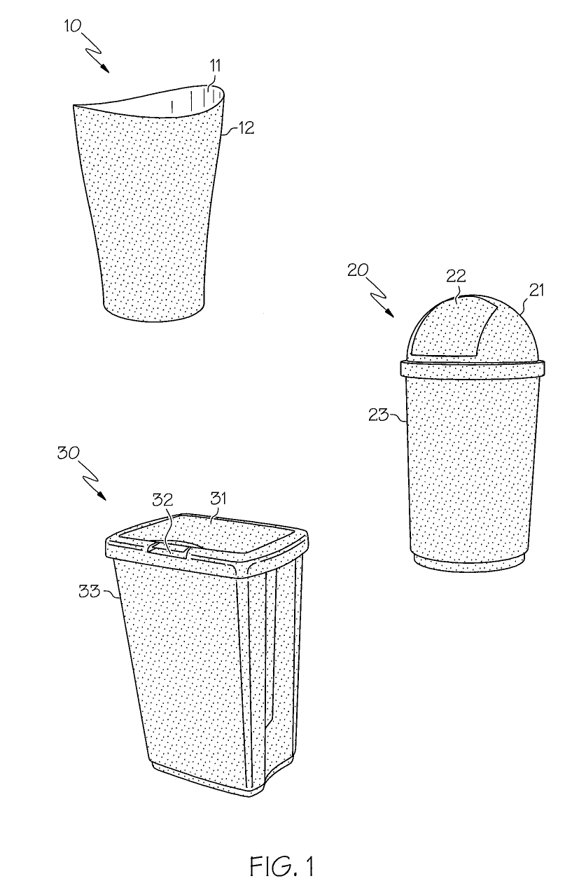

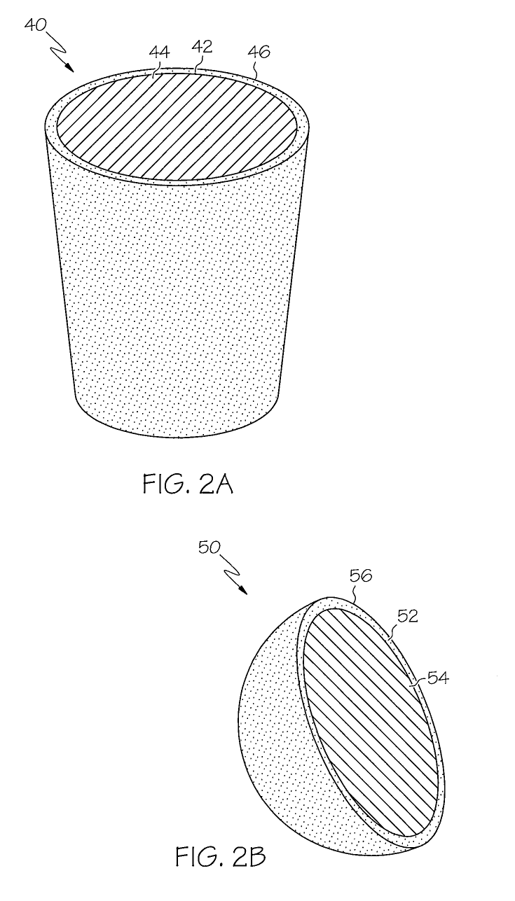

FIG. 1 shows groups of powder coated plastic trash receptacles according to example embodiments of the present invention. To illustrate the present invention, the terms trash container, waste container, trash receptacle, and waste receptacle will be used interchangeably. The figure shows groups 10, 20, 30 of powder coated plastic trash receptacles of different shapes where each includes an inner surface and an outer surface. Each trash receptacle is made of a plastic material and has an interior space for receiving waste. Each trash receptacle is defined by an inside surface and an outer surface. The inside surface exposes the plastic material. A powder coating is applied to at least a portion of the outer surface increasing the aesthetic look of the plastic waste container. The portion may consist of an entire outer surface or some portion less than the entire outer surface (e.g., a large or small portion of the outer surface). A line on a rim at the top of each trash receptacle (illustrated in FIG. 2A) may exist that separates the inside surface plastic material from the powder coated outer surface. For embodiments of the present invention having a cover portion, a line on a rim at the bottom of each cover may exist that separates the inside surface plastic material from the powder coated outer surface, (illustrated in FIG. 2B). The exposed inner surface allows easy cleaning without the worry of damaging a finish on the inner surface.

In the first trash receptacle group 10, each trash receptacle may have an elliptical-type cross-sectional shape where a diameter of each trash receptacle may decrease from the top to the bottom. The trash receptacles in this group of trash receptacles 10 have an open top. Although no cover portion is shown, embodiments of the present invention may include a cover portion that removably fits over the top of the trash receptacle. Further, this group of trash receptacles 10 has an inner surface 11 and an outer surface 12 where the outer surface 12 has been powder coated.

In the second trash receptacle group 20, each trash receptacle may have a circular cross-sectional shape where a diameter of each trash receptacle may be slightly larger at the top than at the bottom. The trash receptacles in this group of trash receptacles 20 have a container portion 23 with an open top. Moreover, the trash receptacles in this group of trash receptacles 20 may have a removable dome-shaped cover portion 21 that can be removably placed over the top of the container portion 23. The dome-shaped cover portion 21 may include a center portion 22 that is pivotably attached to an upper portion of the dome-shaped cover portion 21 in a manner allowing the center portion 22 to swing out on each side of the dome-shaped cover portion 21 in a lateral direction for trash insertion into the trash receptacle. Further, the container portion 23 of the group of trash receptacles 20 has an inner surface (not shown) and an outer surface 23 where the outer surface has been powder coated. In this example embodiment, the outer surface of the removable dome-shaped cover portion 21 has also been powder coated.

In the third trash receptacle group 30, each trash receptacle has a rectangular cross-sectional shape where an area of each trash receptacle may be larger at the top than at the bottom. The trash receptacles in this group of trash receptacles 30 have a container portion 33 with an open top with a removable flat cover portion 31 that can be placed over the top of the container portion 33. The flat cover portion 31 may include a portion 32 that is pivotably attached to a portion of the flat cover portion 31 in a manner allowing the portion 32 to swing up for trash insertion into the trash receptacle. Further, the container portion 33 in this group of trash receptacles 30 has an inner surface (not shown) and an outer surface 32 where the outer surface has been powder coated. The removable cover portion 31 has also been powder coated.

In these example embodiments, the outer surface or walls of the waste receptacles have been powder coated adding aesthetic value to the look of the waste containers. The powder coating may be any color and may be of a different color than the plastic inner surface. For example, the interior surface may be black and the outer surface a bright metallic color. As shown in the figure, the consumer good may be of any shape or color on the outer surface or the inner surface. The application of the powder coating being applied to the outer surface, regardless of shape, texture, or color, increases the aesthetic look of the non-metal consumer good. Although in this example embodiment the powder coating has been applied to the entire outer surface of the non-metal consumer goods, embodiments where the powder coating may be applied to only a portion of the outer surface of the consumer good is also within the scope of the present invention.

FIGS. 2A and 2B show a waste receptacle and associated cover, respectively. In FIG. 2A, a waste receptacle 40 is shown where a line 42 on or near a rim of the top of the waste receptacle 40 separates an inside surface 44 from a powder coated outer surface 46 of the waste receptacle 40. Similarly, in FIG. 2B a cover 50 is shown where a line 52 on a rim of the bottom of the cover 50 separates an inside surface 54 from a powder coated outer surface 56 of the cover 50.

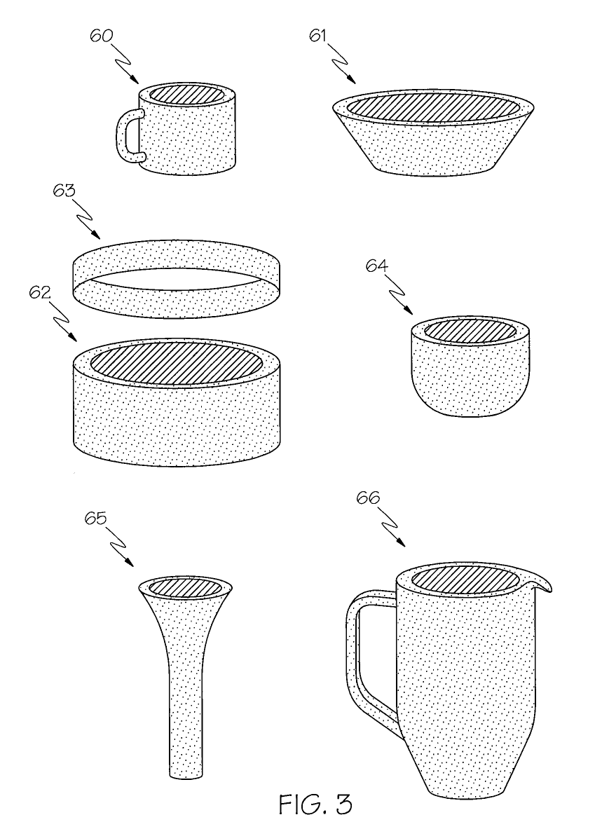

FIG. 3 shows diagrams of example plastic powder coated consumer goods according to example embodiments of the present invention. Powder coated consumer goods according to embodiments of the present invention may be in the form of any type of non-metal consumer good. For example, as shown in FIG. 3, embodiments according to the present invention may be in the form of a drinking cup 60, a basket 61, a storage container 62 that may have an associated cover 63, a bowl 64, a vase 65, or a liquid pitcher 66. Embodiments according to the present invention may be in the form of any other powder coated consumer goods. Although not shown, other examples may include consumer goods such as a bin, a pencil/pen holder, furniture, a tote, a cooler, etc.

Moreover, as noted previously, powder coated consumer goods according to embodiments of the present invention may be made of any type of non-metal material (e.g., plastic, ceramic, wood, etc.) and coated by using any type of powder coating process. Further, as noted previously, powder coated consumer goods according to embodiments of the present invention may have a line on a rim at the top of each that separates the inside surface plastic material from the powder coated outer surface. For embodiments of the present invention having an associated cover portion, a line on a rim at the bottom of each cover may exist that separates the inside surface plastic material from the powder coated outer surface.

It is noted that the foregoing examples have been provided merely for the purpose of explanation and are in no way to be construed as limiting of the present invention. While the present invention has been described with reference to a preferred embodiment, it is understood that the words that have been used herein are words of description and illustration, rather than words of limitation. Changes may be made within the purview of the appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather, the present invention extends to all functionally equivalent structures, methods and uses, such as are within the scope of the appended claims.

What is claimed is:

1. A non-metal consumer good comprising:
a non-metal consumer good, the consumer good having an outer surface and an inner surface,
wherein at least a portion of the outer surface has a powder coating applied, increasing the aesthetic look of the consumer good.

2. The consumer good according to claim 1, wherein the consumer good is made of plastic.

3. The consumer good according to claim 1, wherein the consumer good is made of ceramic.

4. The consumer good according to claim 1, wherein the consumer good is made of wood.

5. The consumer good according to claim 1, wherein the consumer good comprises a waste container.

6. The consumer good according to claim 1, wherein the consumer good comprises a drinking cup.

7. The consumer good according to claim 1, wherein the consumer good comprises a basket.

8. The consumer good according to claim 1, wherein the consumer good comprises a storage container.

9. The consumer good according to claim 1, wherein the consumer good comprises a bowl.

10. The consumer good according to claim 1, wherein the consumer good comprises a vase.

11. The consumer good according to claim 1, wherein the consumer good comprises a liquid pitcher.

12. The consumer good according to claim 1, wherein the portion comprises one of an entire outer surface or less than the entire outer surface.

13. The consumer good according to claim 1, further comprising a line on a rim at the top of the consumer good, the line separating the inside surface material from the powder coated outer surface.

14. The consumer good according to claim 1, wherein the inside surface material is a different color than the power coating.

15. A waste container comprising:
a receptacle made of a plastic material and having an interior space for receiving waste, the receptacle defined by an inside surface and an outer surface;
said inside surface exposing said plastic material and a powder coating applied to at least a portion of the outer surface increasing the aesthetic look of the waste container.

16. The waste container according to claim 15, wherein the portion comprises one of an entire outer surface or less than the entire outer surface.

17. The waste container according to claim 15, further comprising a line on a rim at the top of the waste container, the line separating the inside surface plastic material from the powder coated outer surface.

18. The waste container according to claim 15, wherein the plastic material is a different color than the powder coating.

19. The waste container according to claim 15, further comprising a waste container cover, the waste container cover being made of the plastic material and removably attachable to a top of the waste container, the waste container cover defined by a cover inside surface and a cover outer surface, said cover inside surface exposing said plastic material and a powder coating applied to at least a second portion of the cover outer surface increasing the aesthetic look of the cover.

20. The waste container according to claim 19, wherein the second portion comprises one of an entire cover outer surface or less than the entire cover outer surface.

21. The waste container according to claim 19, further comprising a line on a rim at the bottom of the cover, the line separating the cover inside surface plastic material from the powder coated cover outer surface.

22. The waste container according to claim 19, wherein the plastic material is a different color than the powder coating.
